(19) United States
(12) Patent Application Publication
(10) Pub. No.: US 2024/0266762 A1
(43) Pub. Date: Aug. 8, 2024

(54) FLAME PROOF TERMINAL BLOCK

(71) Applicant: Hamilton Sundstrand Corporation, Charlotte, NC (US)

(72) Inventor: Thomas Houghton, Rockton, IL (US)

(73) Assignee: Hamilton Sundstrand Corporation, Charlotte, NC (US)

(21) Appl. No.: 18/106,804

(22) Filed: Feb. 7, 2023

(51) Int. Cl. H01R 9/24

(52) U.S. Cl. CPC H01R 9/24

(57) ABSTRACT

A flameproof terminal block has a base portion adapted and configured to hold and electrically insulate a lower portion of one or more electrical terminals from a surrounding area, and a cover portion having a body formed from an electrically-insulative flame-resistant material, the body formed to substantially surround and insulate an upper portion of one or more electrical terminals from a surrounding area, and an outer shell, connected to the body, formed from a flame resistant or flameproof material, and adapted and configured to shield the body from flame.

### BACKGROUND OF THE INVENTION

Commercial aircraft engines and related equipment operate in extreme environments and create extreme environments within and surrounding their own components. Such extreme environments can include severe vibrations and high temperatures. Electrical connections on and near such engines therefore must withstand such extreme conditions.

Ever increasingly stringent requirements necessitate the development of components that withstand ever more challenging parameters. Requirements related to heat and flame resistance and flame self-extinguishing are among parameters where continuous improvement is desirable, or indeed is required.

Terminal blocks, which hold electrical connectors while insulating them from one another and their surroundings, and covers for such terminal blocks, are typically manufactured solely from a single electrically insulative material. Although generally considered satisfactory for their intended purpose, material limitations do not always allow for extreme resistance to flame and for flame self-extinguishing within very low timeframes.

Accordingly, Applicants recognize that there remains a need in the art for improvements to terminal blocks, and terminal block covers that withstand ever higher temperatures, resist ignition, and improve flame self-extinguishing performance. The devices, systems and related methods of the present disclosure provide solutions for these needs.

### SUMMARY OF THE INVENTION

In accordance with the present invention, devices, systems and methods are provided that improve safety and reliability of electrical connections, particularly of terminal blocks, and of devices on which they are installed.

In accordance with one aspect of the invention, a flameproof terminal block is provided that has a base portion adapted and configured to hold and electrically insulate a lower portion of one or more electrical terminals from a surrounding area, and a cover portion having a body formed from an electrically-insulative flame-resistant material, the body formed to substantially surround and insulate an upper portion of one or more electrical terminals from a surrounding area, and an outer shell, connected to the body, formed from a flame resistant or flameproof material, and adapted and configured to shield the body from flame.

The outer shell can be additionally adapted and configured to enhance self-extinguishing of any ignition of the body material.

The subject flameproof terminal blocks can further include mechanical fasteners connecting the outer shell to the body. The mechanical fasteners can be screws. The mechanical fasteners can be rivets.

In accordance with one aspect of the invention, the body can be molded onto the outer shell. An inner surface of the outer shell can be textured to enhance adhesion with the body. The outer shell can be provided with at least one protrusion to enhance engagement with the body. The outer shell can be provided with at least one recess to enhance engagement with the body. The body and outer shell can be attached with an adhesive material.

In accordance with the invention, the electrically-insulative flame-resistant material can be a polyamide-imide material. The flame resistant or flameproof material can be a metal. The metal can be a stainless steel alloy. The flame resistant or flameproof material can be selected from the group consisting of ceramics and polymers.

In accordance with another aspect of the invention, a method of enhancing flame resistance of a terminal block includes the steps of providing a base portion adapted and configured to hold and electrically insulate a lower portion of one or more electrical terminals from a surrounding area, and providing a cover portion, the cover portion having a body formed from an electrically-insulative flame-resistant material, the body formed to substantially surround and insulate an upper portion of one or more electrical terminals from a surrounding area, and an outer shell, connected to the body, formed from a metal material, and adapted and configured to shield the body from flame.

The outer shell can additionally be and configured to enhance self-extinguishing of any ignition of the body material.

### BRIEF DESCRIPTION OF THE DRAWINGS

So that those skilled in the art to which the subject disclosure appertains will readily understand how to make and use the devices, systems and methods of the subject disclosure without undue experimentation, embodiments thereof will be described in detail herein below with reference to certain figures, wherein:

FIG. 1 is an isometric top view of a first embodiment of a flameproof terminal block cover, in accordance with the invention;

FIG. 2 is an isometric bottom view of the flameproof terminal block cover of FIG. 1;

FIG. 3 is a side view of the flameproof terminal block cover of FIG. 1;

FIG. 4 is an end view of the flameproof terminal block cover of FIG. 1, shown on top of a companion terminal block, in accordance with the invention;

FIG. 5 is a top view of the flameproof terminal block cover of FIG. 1;

FIG. 6 is a bottom view of an outer shell of the flameproof terminal block cover in accordance with one embodiment of the invention;

FIG. 7 is an isometric top view of a second embodiment of a flameproof terminal block cover, in accordance with the invention;

FIG. 8 is an isometric bottom view of the flameproof terminal block cover of FIG. 7;

FIG. 9 is a side view of the flameproof terminal block cover of FIG. 7;

FIG. 10 is an end view of the flameproof terminal block cover of FIG. 7, shown on top of a companion terminal block, in accordance with the invention;

FIG. 11 is a top view of the flameproof terminal block cover of FIG. 7;

FIG. 12 is a bottom view of an outer shell of the flameproof terminal block cover in accordance with an embodiment of the invention;

FIG. 13 is a bottom view of an outer shell of the flameproof terminal block cover in accordance with another embodiment of the invention;

FIG. 14 is a bottom view of an outer shell of the flameproof terminal block cover in accordance with still another embodiment of the invention;

FIG. 15 is an illustration of a discrete surface feature to enhance bonding between a body and shell of a flameproof terminal block cover in accordance with the invention, wherein the surface features project outwardly from a lower surface of the shell; and

FIG. 16 is an illustration of a discrete surface feature to enhance bonding between a body and shell of a flameproof terminal block cover in accordance with the invention, wherein the surface features project inwardly into a lower surface of the shell.

### DETAILED DESCRIPTION OF THE INVENTION

Reference will now be made to the drawings wherein like reference numerals identify similar structural features or aspects of the subject disclosure.

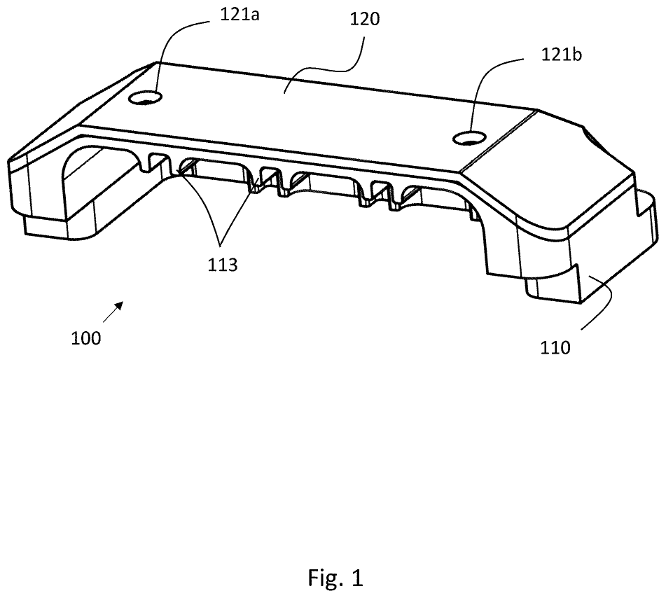

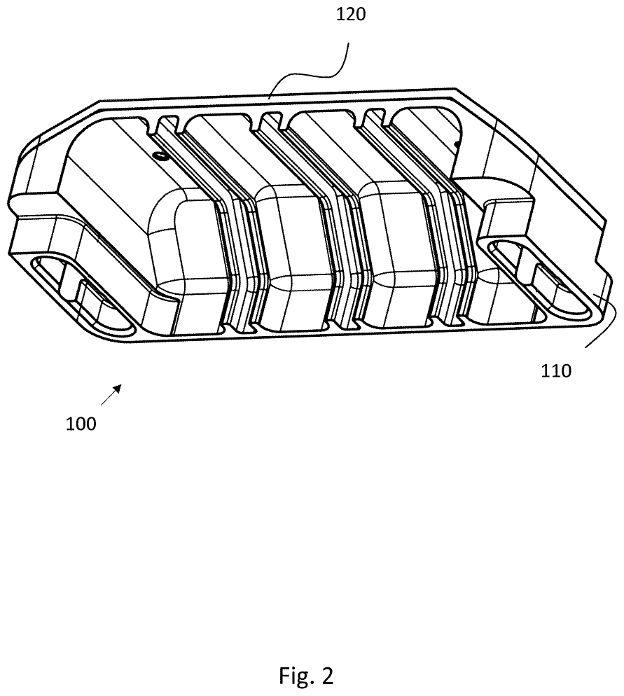

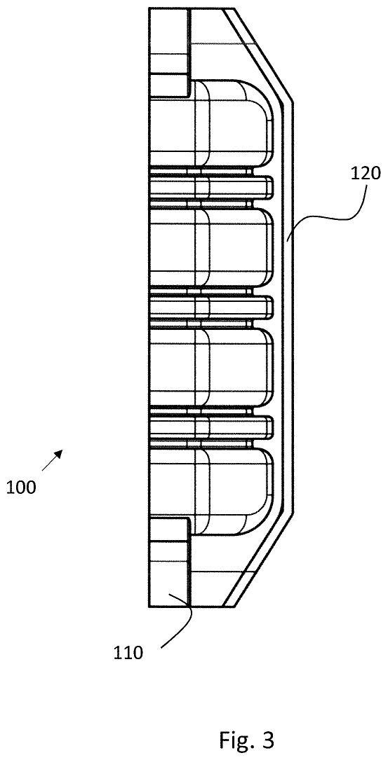

With reference to FIGS. 1-3, and in accordance with one aspect of the present invention, a flameproof terminal block cover is illustrated and is designated, generally by reference number 100. The flameproof terminal block cover 100, as embodied, includes a lower portion or body 110 and an upper portion or shell 120. The body 110 and shell 120 portions can be joined in a number of manners, as will be discussed further below. In the embodiment of FIG. 1, holes 121a, 121b are provided to permit connection with mechanical fasteners, such as screws, bolts, rivets, or the like. The basic form of the flameproof terminal block cover 100 can be adapted as necessary for the particular desired implementation. In the embodiment illustrated in FIG. 1, the flameproof terminal block cover 100 includes a plurality of ribs, which are adapted to engage with corresponding divisions 113 on the terminal block to enhance isolation of terminals from adjacent terminals.

In order to resist ignition due to heat or direct contact with flame, the body 110 is preferably made from a heat and flame resistant electrically insulative polymer material. Such materials include polyamide-imide, polybenzimidazole and Fastblock® 301, a two part addition cured low-density solvent-free aircraft firewall structure sealant/adhesive and fabrication molding compound made by TA Aerospace of Valencia California, for example. Although such materials do perform reasonably well under extreme conditions, there is still a need for enhanced performance.

Accordingly, the shell 120 is provided to shield the body 110 and in-turn the terminal block it is attached to from direct contact with flame, and to help keep the flameproof terminal block cover 100 and its terminal block from continuing to burn. That is, the addition of the shell 120 reduces the time of self-extinguishing of the material of the body 110.

The shell 120 can be formed from any desirable flame resistant or flameproof material, including metals, ceramics, or even polymers that might be unsuitable for other components of the terminal block or cover but are useful for their flame resistance properties, or composites of one or more of such materials. Materials that can advantageously be applied to form the shell 120 include iron-based alloys, such as steel alloys, stainless steel alloys, cobalt, molybdenum, nickel and/or chromium-based alloys. Optionally, ceramics such as porcelain, glass compositions or composites utilizing high content of mineral-based fillers can be used, for example.

The higher flame-resistance of the shell 120 material provides protection of the underlying layers of terminal block and cover, and helps extinguish any ignition of such layers by reducing surface area of materials that may be prone to ignition, however slight that may be. Accordingly, improved resistance to heat and ignition is achieved, along with improved self-extinguishing characteristics.

Due to the form of the body 110, the shell 120 is provided with a central upper region with angled portions sloping downward from one edge and opposing ends thereof. It is to be understood that the shell 120 can be formed to extend continually downward in order to protect the vertical side and end walls of the terminal block cover 110, and indeed also the side and end walls of the terminal block itself. In this manner, the total exposed surface area of the body 110 can be further minimized.

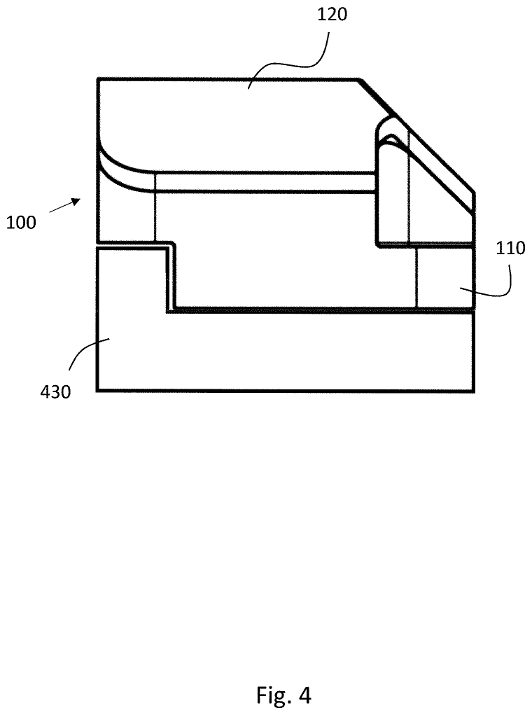

FIG. 4 illustrates the flameproof terminal block cover 100 installed on a companion terminal block 430. The terminal block 430 can be formed of any of the materials already set forth above in connection with the material used for the body 110 of the flameproof terminal block cover 100.

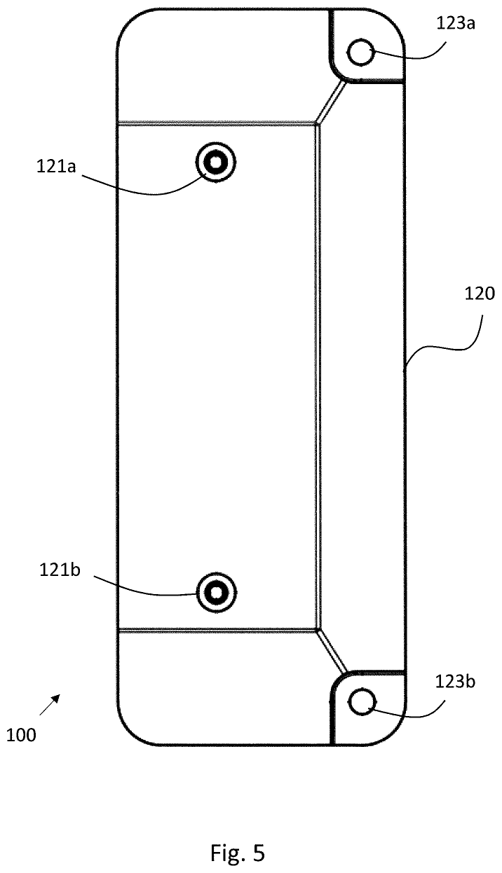

FIG. 5 is a top view of the flameproof terminal block cover 100 illustrating holes 121a, 121b for joining the body 110 and shell 120. Also illustrated are holes 123a, 123b formed in the body 110 for securing the flameproof terminal block cover 100 to the terminal block 430 with mechanical fasteners.

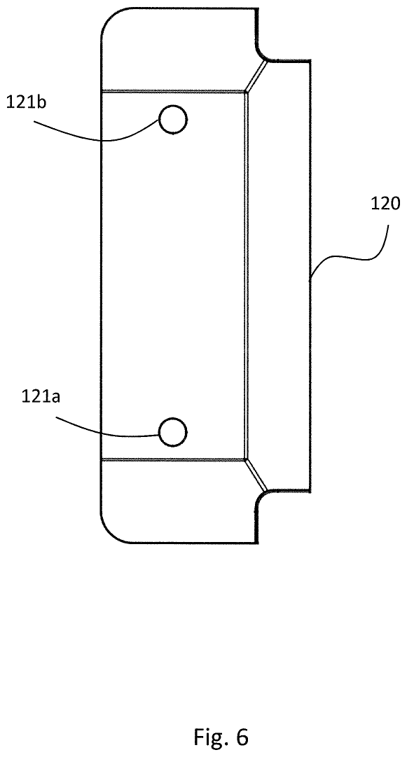

FIG. 6 is a bottom view of the shell 120 of the flameproof terminal block cover in accordance with one embodiment of the invention, including holes 121a, 121b for joining the body 110 and shell 120.

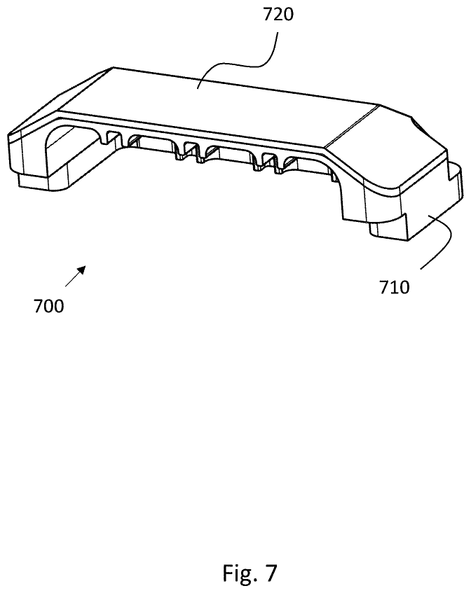

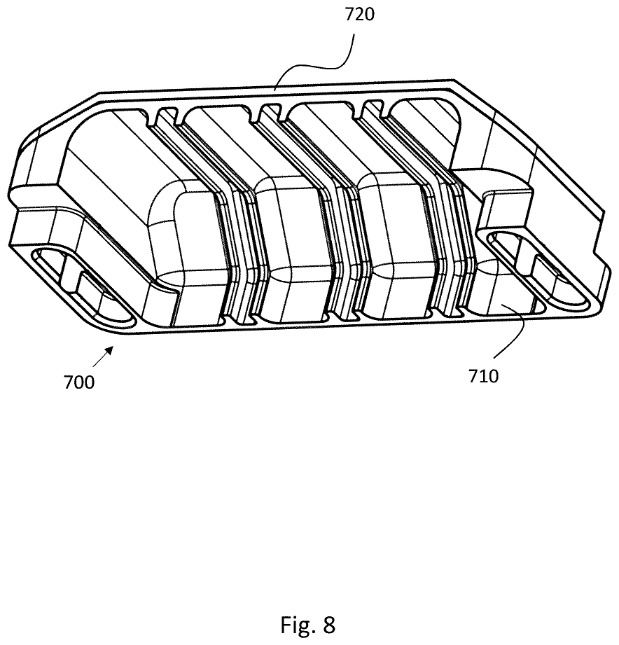

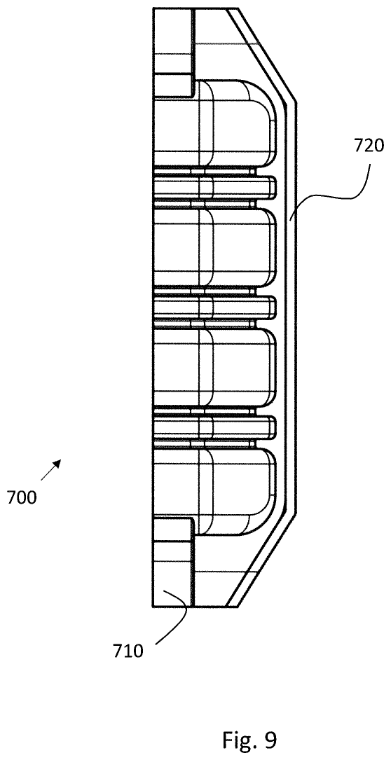

With reference to FIGS. 7-12, and in accordance with an alternate aspect of the present invention, a flameproof terminal block cover is illustrated and is designated, generally by reference number 700. The flameproof terminal block cover 700, as embodied, includes a lower portion or body 710 and an upper portion or shell 720. The body 710 and shell 720 portions can be joined in a number of manners, as will be discussed further below. In the embodiment of FIGS. 7-12, the shell 720 and body 710 are not connected with mechanical fasteners, and accordingly, no holes are provided for that purpose. Instead, the body 710 is molded on to the shell 720, such as by insert molding or overmolding techniques. The materials for use in forming the body 710, shell 720 and companion terminal block 430 can be selected from the materials already set forth above in connection with the embodiment of FIGS. 1-6.

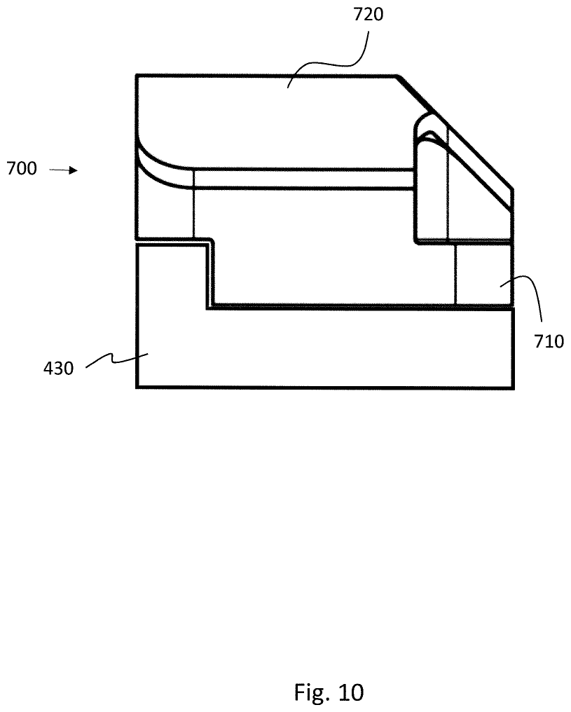

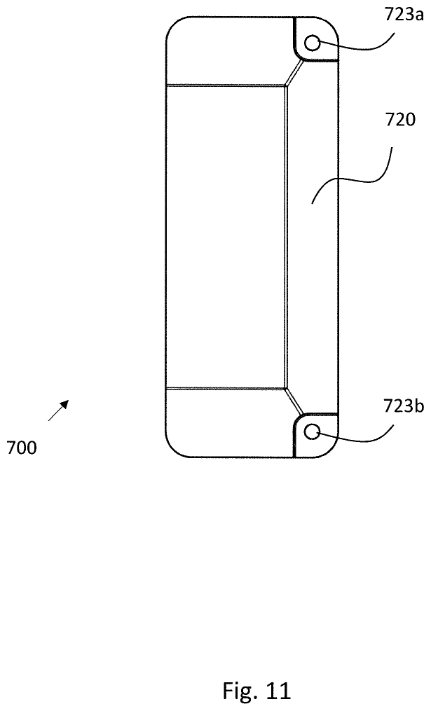

FIG. 10 is an end view of the flameproof terminal block cover of FIG. 7, shown on top of a companion terminal block 430. FIG. 11 is a top view of the flameproof terminal block cover 720 of FIG. 7 illustrating holes 723a, 723b formed in the body for attachment to the terminal block 430.

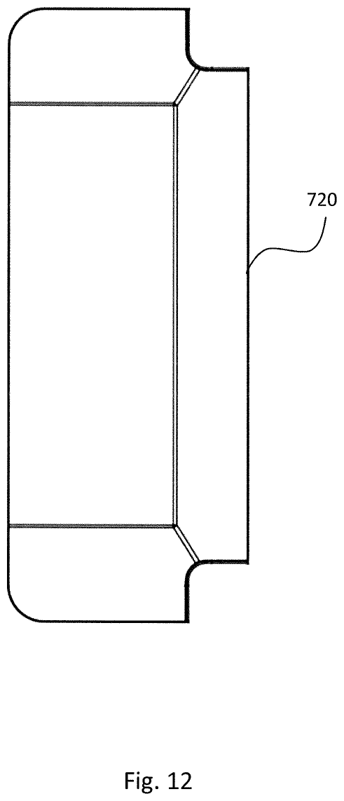

FIG. 12 is a bottom view of an outer shell 720 of the flameproof terminal block cover in accordance with an embodiment of the invention, illustrated without any particular surface enhancements or treatments.

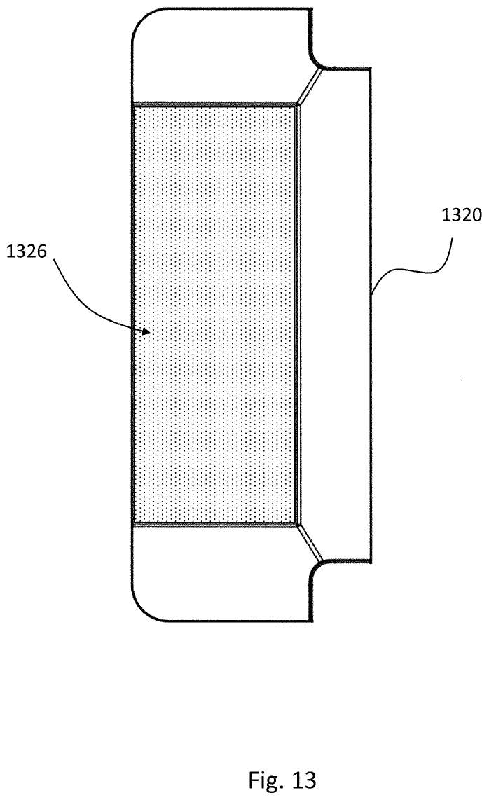

FIG. 13 is a bottom view of an outer shell 1320 of the flameproof terminal block cover in accordance with an alternate embodiment of the invention, illustrated with a surface enhancement 1326 to enhance bonding with the body of a flameproof terminal block cover. Surface enhancement 1326 can be applied to all or a portion of the underside of the outer shell 1320. Enhancements can include textured surface features, such as those achieved by knurling, or etching, such as can be achieved by acid treatment, or by media blasting, such as by abrasive media such as sand, alumina or the like. Additionally or alternatively, surface texture can be stamped or machined into the under surface of the outer shell 1320.

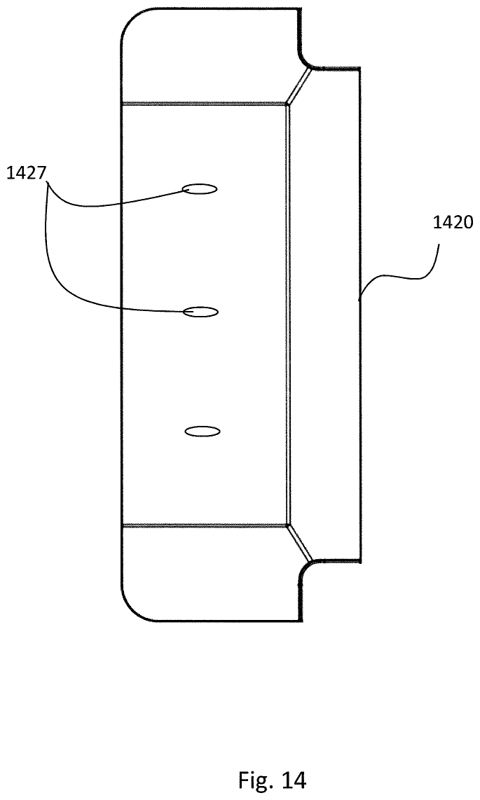

With reference to FIGS. 14-16, FIG. 14 is a bottom view of an outer shell 1420 of the flameproof terminal block cover, in accordance with still another embodiment of the invention. The shell 1420 includes one or more discrete surface features 1427 to enhance engagement with a body of a flameproof terminal block.

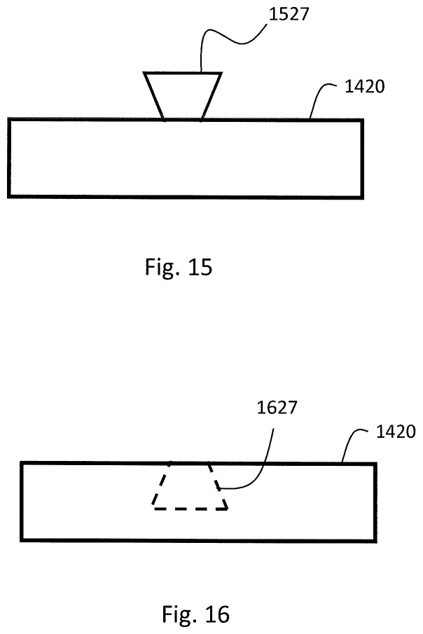

As illustrated in FIG. 15, the surface features 1527 can extend from the central planar area as illustrated or other portions of the shell 1420, and can be attached thereto by suitable techniques, such as welding. Alternatively, to facilitate manufacturability, the shell 1420, as well as any of the foregoing elements, can be formed by additive manufacturing techniques.

Alternatively still, as illustrated in FIG. 16, the surface features 1627 can be formed inwardly, into and below the surface of the shell 1420, forming recesses to allow material of the body of flameproof terminal block cover to flow into the recesses, when molding. Such recesses can be formed with a back cut if desired, leaving the inner end of such recesses wider than the outer opening thereof, and in such a manner can allow the material of the body to mechanically key in to the shell 1420.

While the devices, systems and methods of the subject disclosure have been shown and described with reference to embodiments, those skilled in the art will readily appreciate that changes and/or modifications may be made thereto without departing from the spirit and scope of the subject disclosure.

What is claimed is:

1. A flameproof terminal block having:
a base portion adapted and configured to hold and electrically insulate a lower portion of one or more electrical terminals from a surrounding area; and
a cover portion having:
a body formed from an electrically-insulative flame-resistant material, the body formed to substantially surround and insulate an upper portion of one or more electrical terminals from a surrounding area; and
an outer shell, connected to the body, formed from a flame resistant or flameproof material, and adapted and configured to shield the body from flame.

2. The flameproof terminal block of claim 1, wherein the outer shell is additionally adapted and configured to enhance self-extinguishing of any ignition of the body material.

3. The flameproof terminal block of claim 1, further comprising:
mechanical fasteners connecting the outer shell to the body.

4. The flameproof terminal block of claim 3, wherein the mechanical fasteners are screws.

5. The flameproof terminal block of claim 3, wherein the mechanical fasteners are rivets.

6. The flameproof terminal block of claim 1, wherein the body is molded onto the outer shell.

7. The flameproof terminal block of claim 6, wherein an inner surface of the outer shell is textured to enhance adhesion with the body.

8. The flameproof terminal block of claim 6, wherein the outer shell is provided with at least one protrusion, to enhance engagement with the body.

9. The flameproof terminal block of claim 6, wherein the outer shell is provided with at least one recess, to enhance engagement with the body.

10. The flameproof terminal block of claim 1, wherein the body and outer shell are attached with an adhesive material.

11. The flameproof terminal block of claim 1, wherein the electrically-insulative flame-resistant material is a polyamide-imide material.

12. The flameproof terminal block of claim 1, wherein the flame resistant or flameproof material is a metal.

13. The flameproof terminal block of claim 12, wherein the metal is a stainless steel alloy.

14. The flameproof terminal block of claim 1, wherein the flame resistant or flameproof material is selected from the group consisting of ceramics and polymers.

15. A method of enhancing flame resistance of a terminal block, comprising the steps of:
providing a base portion adapted and configured to hold and electrically insulate a lower portion of one or more electrical terminals from a surrounding area, and
providing a cover portion, the cover portion having:
a body formed from an electrically-insulative flame-resistant material, the body formed to substantially surround and insulate an upper portion of one or more electrical terminals from a surrounding area; and
an outer shell, connected to the body, formed from a metal material, and adapted and configured to shield the body from flame.

16. The method of claim 15, wherein the outer shell is additionally adapted and configured to enhance self-extinguishing of any ignition of the body material.
